(19) United States
(12) Patent Application Publication
(10) Pub. No.: US 2015/0069021 A1
(43) Pub. Date: Mar. 12, 2015

(54) APPARATUS AND METHOD FOR REDUCING ELECTRICAL ARCING IN A CIRCUIT BREAKER WHILE TRANSITIONING TO A CLOSED CIRCUIT CONDITION

(71) Applicant: Siemens Industry, Inc., Alpharetta, GA (US)

(72) Inventor: Guang Yang, Suwanee, GA (US)

(21) Appl. No.: 14/331,955

(22) Filed: Jul. 15, 2014

Related U.S. Application Data
(60) Provisional application No. 61/876,246, filed on Sep. 11, 2013.

(51) Int. Cl. H01H 33/40

(52) U.S. Cl. CPC H01H 33/40; H01H 2235/02; H01H 2221/03; H01H 2205/002; H01H 2201/002
USPC 218/154

(57) ABSTRACT

Apparatus and method for reducing formation of electrical arcing in a circuit breaker while transitioning to a closed circuit condition are disclosed. An electrical contact assembly (12) includes a stationary contact (14) and a movable contact (18) responsive to an operating mechanism (22) to move towards the stationary contact and initiate a closed circuit condition. An oscillatory element (30) is disposed opposite a side of the stationary contact that makes contact with the movable contact during the closed circuit condition. The oscillatory element is configured to provide a transient response effective to adapt shock energy resulting from impact of the movable contact with the stationary contact to joint oscillatory motion so that the stationary contact and the movable contact remain interconnected to one another during the joint oscillatory motion, thus reducing formation of electrical arcing while transitioning to the closed circuit condition.

This application claims benefit of the Sep. 11, 2013 filing date of U.S. provisional application 61/876,246, which is incorporated by reference herein.

### FIELD OF THE INVENTION

Disclosed embodiments are related to circuit breakers, and, more particularly, to apparatus and method for reducing formation of electrical arcing in a circuit breaker while transitioning to a closed circuit condition.

### BACKGROUND OF THE INVENTION

Circuit breakers are commonly used to protect electrical circuits or systems from certain abnormal conditions. In thermo-magnetic circuit breakers, typically, an electrical contact assembly, such as involving a stationary contact and a movable contact, is used to open and close the circuit. Circuit breakers can develop relatively high forces to drive the movable contact during a circuit closing event, and hence high impact can occur between such electrical contacts. This high impact can create a bouncing condition in the movable contact, and during this condition, momentary separations may be formed between such contacts, which can lead to the formation of electrical arcing between the contacts. This electrical arcing can cause damage to the contacts and could potentially lead to contact welding.

### BRIEF DESCRIPTION OF THE DRAWINGS

The invention is explained in the following description in view of the drawings that show:

FIG. 1 is a schematic of an apparatus, such as a circuit breaker, that can benefit from aspects of the present invention.

FIGS. 2 and 3 are respective schematics for conceptualizing aspects of the present invention.

FIGS. 4 and 5 are schematics respectively illustrating a non-limiting embodiment of an apparatus embodying aspects of the present invention.

FIGS. 6 and 7 are plots useful for comparing a typical response of a prior art circuit breaker involving a bouncing condition (FIG. 6) relative to a non-limiting example response (FIG. 7) of a circuit breaker embodying aspects of the present invention.

FIG. 8 is flow chart of a method embodying aspects of the present invention.

### DETAILED DESCRIPTION OF THE INVENTION

The inventor of the present invention proposes an innovative contact structure that cost-effectively and reliably is effective for reducing formation of electrical arcing in a circuit breaker while transitioning to a closed circuit condition. Typically, an operating mechanism in the circuit breaker can drive electrical contacts at relatively high speeds and hence can produce a relatively high impact in the electrical contacts, which can lead to a bouncing condition where momentary air gaps may be formed between the electrical contacts, which in turn can lead to the formation of electrical arcing between such electrical contacts.

FIG. 1 is a schematic of an apparatus 10, such as a circuit breaker, that can benefit from aspects of the present invention. In one non-limiting embodiment, an electrical contact assembly 12 comprises a stationary contact 14, which may be electrically connected to a power line 16, and a movable contact 18 that may be disposed at an end of a contact arm 20, which may be electrically connected, such as through a load terminal 19 and a load connector 21, to an electrical load (not shown). Movable contact 18 by way of contact arm 20 is responsive to an operating mechanism 22 including an operating spring 24 to move towards the stationary contact and initiate a closed circuit condition. As used herein, the term stationary contact does not preclude transient motion that can occur while transitioning to or from a closed circuit condition. The description below elaborates details in connection with an oscillatory element 30, such as an oscillatory spring, operatively connected to stationary contact 14. As will be appreciated from the description below, oscillatory element 30 may be broadly conceptualized as a shock absorber. As used herein the phrase “configured to” embraces the concept that the feature preceding the phrase “configured to” is intentionally and specifically designed or made to act or function in a specific way and should not be construed to mean that the feature just has a capability or suitability to act or function in the specified way, unless so indicated.

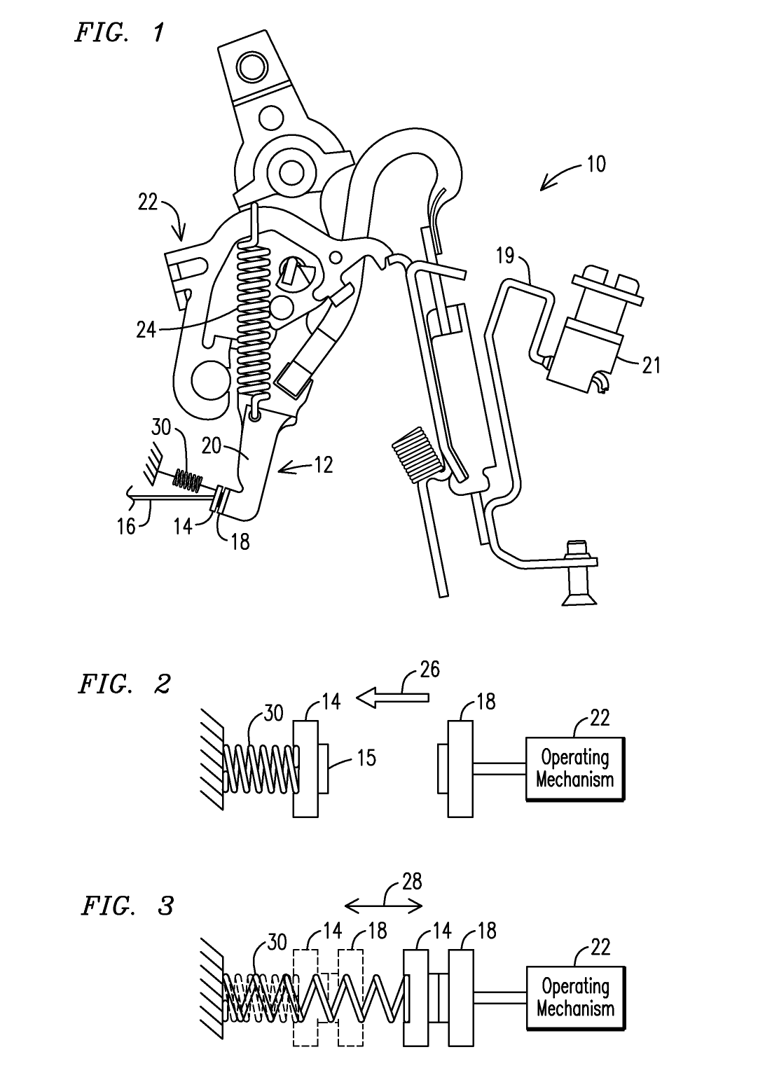

FIGS. 2 and 3 are respective schematics for conceptualizing aspects of the present invention. In one non-limiting embodiment, oscillatory element 30 is disposed opposite a side 15 of stationary contact 14 that makes contact with movable contact 18 during the closed circuit condition. It will be appreciated that aspects of the present invention are not limited to any particular type of oscillatory spring. Non-limiting examples of oscillatory springs may be a compression spring, a leaf spring, a clip spring, an extension spring, an elastomeric spring, etc.

FIG. 2 illustrates an open circuit condition prior to transitioning to a closed circuit condition, where a single-headed arrow 26 represents movement of movable contact 18 towards stationary contact 14 to initiate the closed circuit condition. As may be appreciated in FIG. 3, in one non-limiting embodiment, oscillatory element 30 is configured to provide a transient response effective to adapt shock energy resulting from impact of movable contact 18 with stationary contact 14 to joint oscillatory motion (schematically represented by a twin-headed arrow 28) of stationary contact 14 and movable contact 18, so that stationary contact 14 and movable contact 18 remain interconnected to one another during the joint oscillatory motion, thus reducing formation of electrical arcing during the closed circuit condition.

As will be appreciated by those skilled in the art, to achieve the desired transient response, certain parameters of oscillatory element 30, such as its spring rate, mass, etc., are chosen based on relevant parameters of the structures involved, such as the mass of movable contact 18 and other structures connected to movable contact 18, e.g., contact arm 20, etc., the closing speed of movable contact 18, the spring rate of operating spring 24, the mass of stationary contact 14, etc. Broadly, in a given application, oscillatory element 30 can be tailored to achieve the desired transient response based on relevant parameters of the structures involved in the given application.

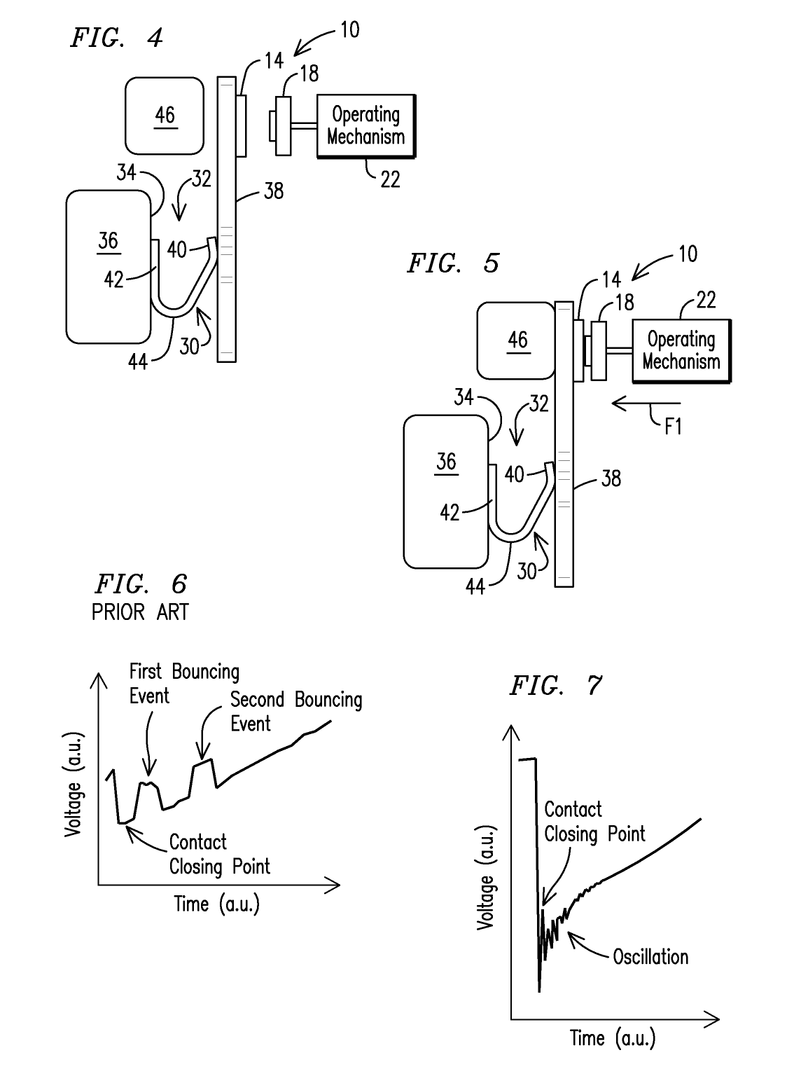

FIGS. 4 and 5 are schematics respectively illustrating a non-limiting embodiment of an apparatus 10 embodying aspects of the present invention. FIG. 4 illustrates an open circuit condition prior to transitioning to a closed circuit condition, and FIG. 5 illustrates a closed circuit in a steady state condition subsequent to the transient response. That is, subsequent to the joint oscillatory motion discussed above in the context of FIG. 3.

In this embodiment, oscillatory element 30, such as a spring clip, is disposed in a pocket 32 formed between an inner wall 34 of a housing 36 of the apparatus and a contact terminal 38 connected to stationary contact 14. Spring clip 30 may comprise a first leg 40 affixed to contact terminal 38 and a second leg 42 connected to first leg 40 through a conjoining section 44 of spring clip 30. Second leg 42 of spring clip 30 is affixed to inner wall 34 of housing 36 of the apparatus. In this embodiment, a mechanical stop 46 is disposed opposite the side of stationary contact 14 that makes contact with movable contact 18.

As may be appreciated in FIG. 5, mechanical stop 46 is configured to limit travel of stationary contact 14 during the closed circuit condition. This travel occurs in response to an urging force (labeled F1) applied by operating mechanism 22 against stationary contact 14 through movable contact 18 during the steady state condition, subsequent to the transient response. Thus, it will be appreciated that after completion of the joint oscillatory motion of stationary contact 14 and movable contact 18, oscillatory element 30 is overcome by urging force F1 and thus, in the steady state condition—and opposite to the joint contact engagement achieved during the transient response—the role played by oscillatory spring 30 between stationary contact 14 and movable contact 18 is practically nil. That is, during the steady state condition, subsequent to the transient response, oscillatory element 30 is practically inactive for purposes of engagement of the stationary contact and the movable contact to one another. This is opposite to certain prior art contact structures that rely on biasing forces from a biasing spring positioned behind the stationary contact to enhance the contact between the electrical contacts.

Thus, in one non-limiting embodiment, oscillatory element 30 may be characterized as comprising an active mode (analogous to a shock absorber) during the transient response (e.g., the joint oscillatory motion) that occurs while transitioning to the closed circuit condition for purposes of engagement of the stationary contact with the movable contact. Oscillatory element 30 may be further characterized as, during the steady state condition subsequent to the joint oscillatory motion, comprising an inactive mode for purposes of engagement of the stationary contact with the movable contact.

FIGS. 6 and 7 are plots depicting respective voltage traces useful for comparing a typical response of a prior art circuit breaker involving a contact structure susceptible to a bouncing condition (FIG. 6) relative to a non-limiting example response (FIG. 7) of a circuit breaker embodying aspects of the present invention. FIG. 6 illustrates a voltage trace indicative of a bouncing condition lasting approximately 1 millisecond and comprising two bouncing events where electrical arcing may be formed.

FIG. 7 illustrates a voltage trace indicative of a joint oscillatory motion of the stationary contact and the movable contact lasting approximately ⅓ of the total bouncing time discussed in the context of FIG. 6. In this case, the stationary contact and the movable contact remain interconnected to one another during the joint oscillatory motion, and thus in accordance with aspect of the present invention the disclosed apparatus is effective for reducing formation of electrical arcing while transitioning to the closed circuit condition.

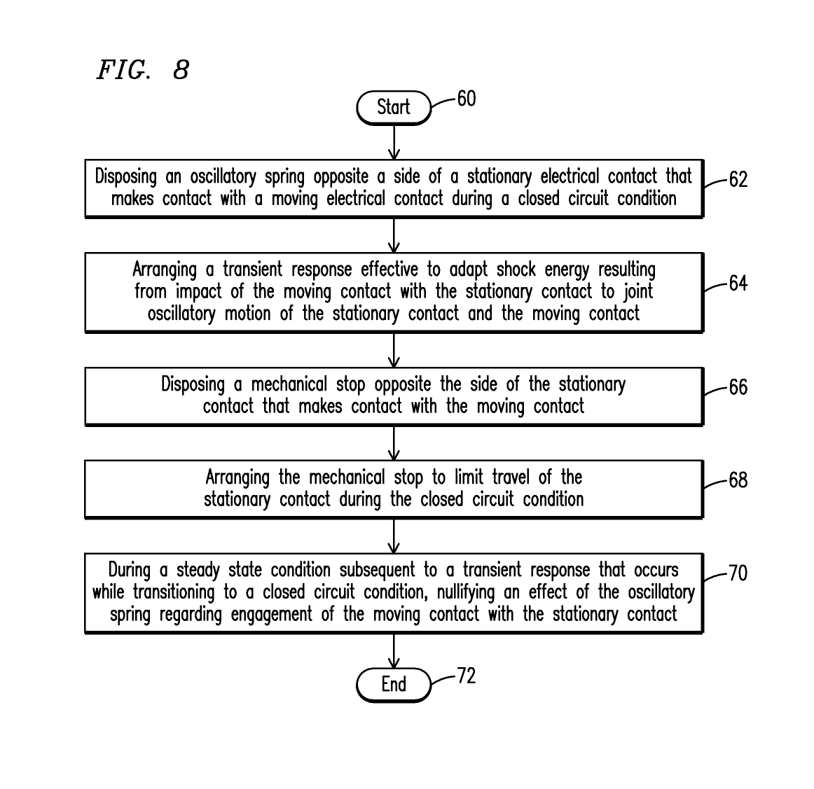

FIG. 8 is flow chart of a method embodying aspects of the present invention. Subsequent to start step 60, step 62 allows disposing an oscillatory spring opposite a side of a stationary electrical contact that makes contact with a movable electrical contact during a closed circuit condition. Step 64 allows arranging a transient response by way of the oscillatory spring effective to adapt shock energy resulting from impact of the movable contact with the stationary contact to joint oscillatory motion of the stationary contact and the movable contact. The stationary contact and the movable contact remain interconnected to one another during the joint oscillatory motion, thus reducing formation of electrical arcing while transitioning to the closed circuit condition. Step 66 allows disposing a mechanical stop opposite the side of the stationary contact that makes contact with the movable contact. Step 68 allows arranging the mechanical stop to limit travel of the stationary contact during the closed circuit condition.

The travel of the stationary contact occurs in response to an urging force applied by an operating mechanism against the stationary contact during a steady state condition subsequent to the dynamic transient response. In the steady state condition, the oscillatory spring is overcome by the urging force and consequently—opposite to the joint contact engagement achieved during the transient response—the role played by the oscillatory spring for engaging the stationary contact and the movable contact to one another is practically nil; thus practically inactivating the oscillatory element during the steady state condition regarding engagement of the stationary contact with the movable contact. Thus, as illustrated in step 70, prior to stop step 72, in one non-limiting embodiment, this overcoming of the oscillatory spring by the urging force applied by the operating mechanism, in effect, during the steady state condition, allows nullifying an effect of the oscillatory spring regarding engagement of the stationary contact with the movable contact.

While various embodiments of the present invention have been shown and described herein, it will be apparent that such embodiments are provided by way of example only. Numerous variations, changes and substitutions may be made without departing from the invention herein. Accordingly, it is intended that the invention be limited only by the spirit and scope of the appended claims.

The invention claimed is:

1. Apparatus comprising:
an electrical contact assembly comprising a stationary contact and a movable contact, the movable contact responsive to an operating mechanism to move towards the stationary contact and initiate a closed circuit condition; and
an oscillatory element disposed opposite a side of the stationary contact that makes contact with the movable contact during the closed circuit condition, the oscillatory element configured to provide a transient response effective to adapt shock energy resulting from impact of the movable contact with the stationary contact to joint oscillatory motion of the stationary contact and the movable contact, wherein the stationary contact and the movable contact remain interconnected to one another during the joint oscillatory motion, thus reducing formation of electrical arcing while transitioning to the closed circuit condition.

2. The apparatus of claim 1, wherein the oscillatory element comprises a spring.

3. The apparatus of claim 2, wherein the spring is selected from the group consisting of a compression spring, a leaf spring, a clip spring, an extension spring and an elastomeric spring.

4. The apparatus of claim 1, further comprising a mechanical stop disposed opposite the side of the stationary contact that makes contact with the movable contact, the mechanical stop configured to limit travel of the stationary contact during the closed circuit condition, the travel occurring in response to an urging force applied by the operating mechanism against the stationary contact during a steady state condition subsequent to the transient response.

5. The apparatus of claim 4, wherein, during the steady state condition, the oscillatory element is overcome by the urging force applied by the operating mechanism, and thus the oscillatory element being practically inactive during the steady state condition regarding engagement of the stationary contact with the movable contact.

6. The apparatus of claim 1, wherein the oscillatory element is disposed in a pocket formed between an inner wall of a housing of the apparatus and a contact terminal connected to the stationary contact.

7. The apparatus of claim 6, wherein the oscillatory element comprises a spring clip comprising a first leg affixed to the contact terminal and a second leg connected to the first leg through a conjoining section of the spring clip, wherein the second leg of the spring clip is affixed to the inner wall of the housing of the apparatus.

8. The apparatus of claim 1, wherein the oscillatory element comprises an active mode regarding engagement of the stationary contact with the movable contact during the transient response, and further wherein, in a steady state condition subsequent to the transient response, the oscillatory element comprises an inactive mode regarding engagement of the stationary contact with the movable contact.

9. A circuit breaker comprising the apparatus of claim 1.

10. Apparatus comprising:
an oscillatory spring disposed opposite a side of a stationary electrical contact that makes contact with a movable electrical contact during a closed circuit condition, the oscillatory spring configured to provide a transient response effective to adapt shock energy resulting from impact of the movable contact with the stationary contact to joint oscillatory motion of the stationary contact and the movable contact, wherein the stationary contact and the movable contact remain interconnected to one another during the joint oscillatory motion; and
a mechanical stop disposed opposite the side of the stationary contact that makes contact with the movable contact, the mechanical stop configured to limit travel of the stationary contact during the closed circuit condition, the travel occurring in response to an urging force applied by an operating mechanism against the stationary contact during a steady state condition subsequent to the transient response.

11. The apparatus of claim 10, wherein, during the steady state condition, the oscillatory spring is overcome by the urging force applied by the operating mechanism, and thus the oscillatory element being practically inactive during the steady state condition regarding engagement of the stationary contact with the movable contact.

12. The apparatus of claim 10, wherein the oscillatory spring is selected from the group consisting of a compression spring, a leaf spring, a clip spring, an extension spring and an elastomeric spring.

13. The apparatus of claim 10, wherein the oscillatory spring is disposed in a pocket formed between an inner wall of a housing of the apparatus and a contact terminal connected to the stationary contact.

14. The apparatus of claim 13, wherein the oscillatory spring comprises a spring clip comprising a first leg affixed to the contact terminal and a second leg connected to the first leg through a conjoining section of the spring clip, wherein the second leg of the spring clip is affixed to the inner wall of the housing of the apparatus.

15. The apparatus of claim 10, wherein the oscillatory spring comprises an active mode regarding engagement of the stationary contact with the movable contact during the transient response, and further, wherein in the steady state condition subsequent to the transient response, the oscillatory spring comprises an inactive mode regarding engagement of the stationary contact with the movable contact.

16. A circuit breaker comprising the apparatus of claim 10.

17. A method comprising:
disposing an oscillatory spring opposite a side of a stationary electrical contact that makes contact with a movable electrical contact during a closed circuit condition;
arranging a transient response by way of the oscillatory spring effective to adapt shock energy resulting from impact of the movable contact with the stationary contact to joint oscillatory motion of the stationary contact and the movable contact, wherein the stationary contact and the movable contact remain interconnected to one another during the joint oscillatory motion, thus reducing formation of electrical arcing while transitioning to the closed circuit condition;
disposing a mechanical stop opposite the side of the stationary contact that makes contact with the movable contact; and
arranging the mechanical stop to limit travel of the stationary contact during the closed circuit condition, the travel occurring in response to an urging force applied by an operating mechanism against the stationary contact during a steady state condition subsequent to the transient response.

18. The method of claim 17, wherein, during the steady state condition, overcoming the oscillatory spring with the urging force applied by the operating mechanism, thus nullifying an effect of the oscillatory spring regarding engagement of the stationary contact with the movable contact during the steady state condition.
